(19) United States
(12) Patent Application Publication
(10) Pub. No.: US 2005/0069063 A1
(43) Pub. Date: Mar. 31, 2005

(54) Broadband interference cancellation

(75) Inventors: Alan E. Waltho, San Jose, CA (US); David O. Xu, Fremont, CA (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/674,730

(22) Filed: Sep. 30, 2003

(51) Int. Cl. H04L 1/00

(52) U.S. Cl. 375/346

(57) ABSTRACT

A method and apparatus are provided for broadband cancellation of interference signals. A signal transmitted on one communication path acts as an interference signal to a receiver on a second communication path in the system. In an embodiment, a signal transmitted from an antenna using one wireless standard, or protocol, acts as an interference signal for another antenna, co-located in the same system, using another wireless standard, or protocol, and operating in the same or nearby frequency bands. A time delay is applied to a signal sampled from the interference signal to provide substantially broadband cancellation of the interference signal. The sampled signal may be attenuated to match the amplitude of the interference signal on the second communication path. Coupling of the sampled signal from one communication path to the other communication path can provide an 180° phase shift to the sampled signal.

### TECHNICAL FIELD

Embodiments of the invention relate generally to signal interference cancellation.

### BRIEF DESCRIPTION OF THE DRAWINGS

FIG. 1 depicts an embodiment of a system providing broadband cancellation of an interference signal between two signal paths of the system, according to the present invention.

FIG. 2 depicts an embodiment a system having a delay line and an attenuator to provide broadband cancellation of an interference signal between two signal paths of the system, according to the present invention.

FIG. 3 illustrates a block diagram of an embodiment of elements of a system with a broadband canceller having an adjustable delay line, according to the present invention.

FIG. 4 illustrates an embodiment of an adjustable delay line that can be applied in the system of FIG. 3 using a number of microelectromechanical switches, according to the present invention.

FIG. 5 illustrates an embodiment of an adjustable delay line that can be applied in the system of FIG. 3 using a transmission medium having adjustable properties for controlling signal transmission, according to the present invention.

FIG. 6 shows a flowchart of an embodiment of a method for providing broadband cancellation of an interference signal, according to the present invention.

FIG. 7 shows a flowchart of an embodiment of a method for providing broadband cancellation of an interference signal, according to the present invention.

FIG. 8 shows a flowchart of an embodiment of a method for providing broadband cancellation of an interference signal using a test signal, according to the present invention.

FIG. 9 illustrates a block diagram of an embodiment of a system having a broadband canceller, according to the present invention.

FIG. 10 illustrates a block diagram of another embodiment of a system having a broadband canceller, according to the present invention.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the present invention. Other embodiments may be utilized and structural, logical, and electrical changes may be made without departing from the scope of the invention. The various embodiments disclosed herein are not necessarily mutually exclusive, as some disclosed embodiments can be combined with one or more other disclosed embodiments to form new embodiments. The following detailed description is, therefore, not to be taken in a limiting sense, and the scope of the embodiments of the present invention is defined only by the appended claims, along with the full scope of equivalents to which such claims are entitled.

In an embodiment, a method for broadband cancellation of an interference signal includes applying a time delay to a signal sampled from the interference signal to provide substantially broadband cancellation of the interference signal. The amplitude of the sampled signal may also be matched to the amplitude of the interference signal. In an embodiment, the amplitude of the sampled signal is matched to the amplitude of the interference signal to achieve an accurate amplitude balance. Such a method provides cancellation over a wider range of frequencies than methods that generate a signal to match the amplitude and phase of the interference signal, which may typically provide good cancellation at one frequency but much less cancellation at other frequencies. In an embodiment, a method for broadband cancellation of an interference signal including applying a time delay to a signal sampled from the interference signal is implemented on an integrated circuit (IC).

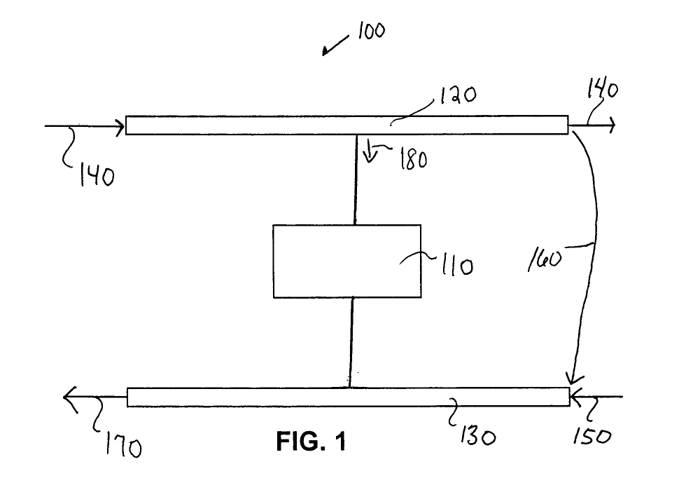

FIG. 1 depicts an embodiment of a system 100 providing broadband cancellation of an interference signal between two signal paths of system 100. System 100 includes a delay line 110 between a first signal path 120 and a second signal path 130. A first signal 140 is coupled to first signal path 120 to be transmitted from first signal path 120 to other sections of system 100 or externally from system 100. First signal 140 may be an internal communication signal or a communication signal for wireless transmission from system 100. A second signal 150 is coupled to second signal path 130 as a received signal in system 100. Second signal 150 is a signal that is being received from a source internal to system 100 or from a source external to system 100. Second signal 150 may be an internal communication signal or a received communication signal from a wireless transmission to system 100. In an embodiment, first signal 140 is a signal transmitted by a first antenna and second signal 150 is a signal received by a second antenna, where the two signals 140, 150 are generated under different wireless standards, or protocols. In an embodiment, first signal 140 is a signal transmitted using a Bluetooth™ standard released in July 1999 by the Bluetooth Special Interest Group (SIG), Inc, and second signal 150 is a signal received using the IEEE 802.11b™ standard, IEEE Std, 802.11b™-1999. Other versions of these standards, such as the Bluetooth™ version issued under IEEE 802.15.1™ standard, IEEE Std, 802.115.1™-2002, published 14 Jun. 2002, and IEEE 802.11g™ standard, IEEE Std, 802.11g™-2003, scheduled for printing 11 Jul. 2003 that extends the data rate of IEEE 802.11b™, or other communication standards may be used in transmitting and receiving signals 140, 150. In an embodiment, system 100 may be an integrated circuit (IC).

In embodiments in which first signal 140 is not intended to be received as second signal 150, the occurrence of first signal 140 on second signal path 130 creates an interference signal 160. With this occurrence, a received signal 170 coupled from second signal path 130 includes both the desired second signal 150 and the interference signal 160. In an embodiment in which first signal 140 is a wireless signal operating under a first protocol and second signal 150 is a wireless signal operating under a second protocol, system 100 operating with these two signals in the same or nearby frequency bands is subject to noise, interference due to interference signal 160. In an alternate embodiment, interference signal 160 is provided by a first signal 140 propagating on a bus of system 100 that receives second signal 150 from an antenna. In another embodiment, interference signal 160 is provided by a first signal 140 propagating on a bus network of system 100 in which a different second signal 150 is received on second signal path 130 from the bus network of system 100.

Delay line 110 provides a time delay to a signal 180 sampled from first signal 140 to provide broadband cancellation of interference signal 160. As a result of this broadband cancellation, received signal 170 is substantially second signal 150. To provide substantially complete broadband cancellation of interference signal 160, the amplitude of sampled signal 180 should match that of interference signal 160. In an embodiment, at second signal path 130, sampled signal 180 has an amplitude matched to the amplitude of interference signal 160 with about a 0.1 dB accuracy. In an embodiment, the amplitude matching is with an accuracy within 0.1 dB. To provide substantially complete broadband cancellation of interference signal 160, sample signal 180 is introduced to second signal path 130 with a phase shifted 180° from the phase of interference signal 160. In an embodiment, about a 180° phase shift is provided to sample signal 180 with about a 90° phase shift applied upon sampling from first path 120 and about a 90° phase shift applied coupling sampled signal 180 to second signal path 130.

With the general applications for system 100 known, system 100 may be designed in which the path length for interference signal 160 and the path length for sampled signal 180 can generally be calculated, or determined. With the elements of system 100 fixed, the amount of time delay for signals 160 and 180 in propagating to second signal path 130 can be initially determined. However, since the complete operating conditions for system 100 are not fixed, delay line 110 is configured to operatively provide a time delay to sampled signal 180. In an embodiment, delay line 110 is adapted to adjust the time delay applied to sampled signal 180 to minimize the signal strength of received signal 170 with the absence of second signal 150.

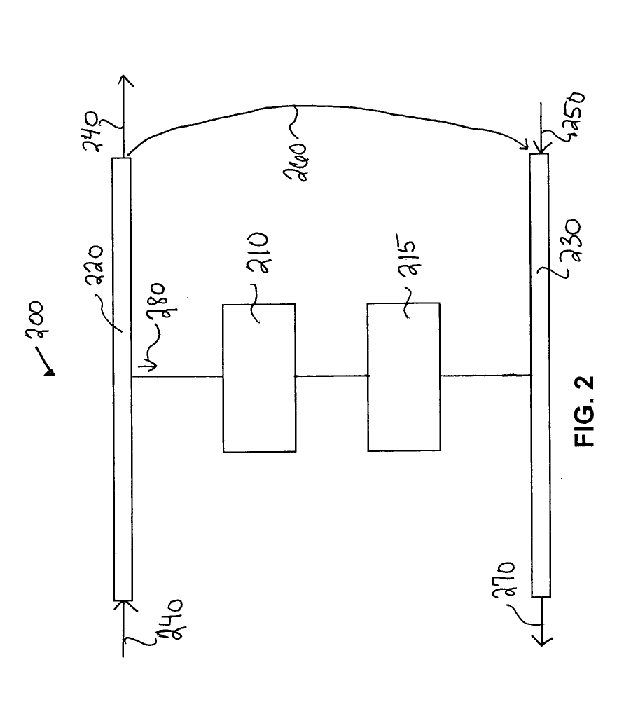

Sampled signal 180 and interference signal 160 travel different paths from the sampling point on first signal path 120. The path for sampled signal 180 from first signal path 120 through delay line 110 to second signal path 130 may be designed such that losses to sampled signal 180 correspond to losses in interference signal 160 along an interference path from first signal path 120 to the point on second signal path 130 at which sampled signal 180 is coupled to second signal path 130. With the paths designed to match losses, the amplitude of sampled signal 180 may be matched to amplitude of interference signal 160. To compensate for variations in the effects of the different paths on the amplitudes of sampled signal 180 and interference signal 160, an attenuator may be coupled to delay line 110 to attenuate sampled signal 180 to match the amplitude of sampled signal 180 to that of interference 180 at second signal path 130. An embodiment including an attenuator is depicted in FIG. 2.

FIG. 2 depicts an embodiment of a system 200 having a delay line 210 and an attenuator 215 to provide broadband cancellation of an interference signal between two signal paths of system 200. System 200 is similar to system 100 of FIG. 1 with the added attenuation element. In addition to delay line 210 and attenuator 215, system 200 includes a first signal path 220 and a second signal path 230. A first signal 240 is coupled to first signal path 220 to be transmitted from first signal path 220 to other sections of system 200 or externally from system 200. First signal 240 may be an internal communication signal or a communication signal for wireless transmission from system 200. A second signal 250 is coupled to second signal path 230 as a received communication signal in system 200. Second signal 250 is a signal that is being received from a source internal to system 200 or from a source external to system 200. Second signal 250 may be an internal communication signal or a received signal from a wireless transmission to system 200. In an embodiment, first signal 240 is a signal transmitted by a first antenna and second signal 250 is a signal received by a second antenna, where the two signals 240, 250 are generated under different wireless standards, or protocols. In an embodiment, system 200 may be an integrated circuit (IC).

Delay line 210 provides a time delay to a signal 280 sampled from first signal 240 to provide broadband cancellation of interference signal 260. As a result of this broadband cancellation, received signal 270 is substantially the same as second signal 250. Attenuator 215 attenuates sampled signal 280 to match the amplitude of sampled signal 280 to the amplitude interference signal 260 at second signal path 230. In an embodiment, this amplitude matching is realized with about a 0.1 dB accuracy. In an embodiment, the amplitude matching has an accuracy within 0.1 dB. In an embodiment, delay line 210 and attenuator 215 are adapted to adjust the time delay and attenuation applied to sampled signal 280 to minimize the signal strength of received signal 270 in the absence of second signal 250.

Sample signal 280 is introduced to second signal path 230 with a phase shifted 180° from the phase of interference signal 260. In an embodiment, about a 180° phase shift is provided to sample signal 280 with about a 90° phase shift applied upon sampling from first path 220 and about a 90° phase shift applied coupling sampled signal 280 to second signal path 230.

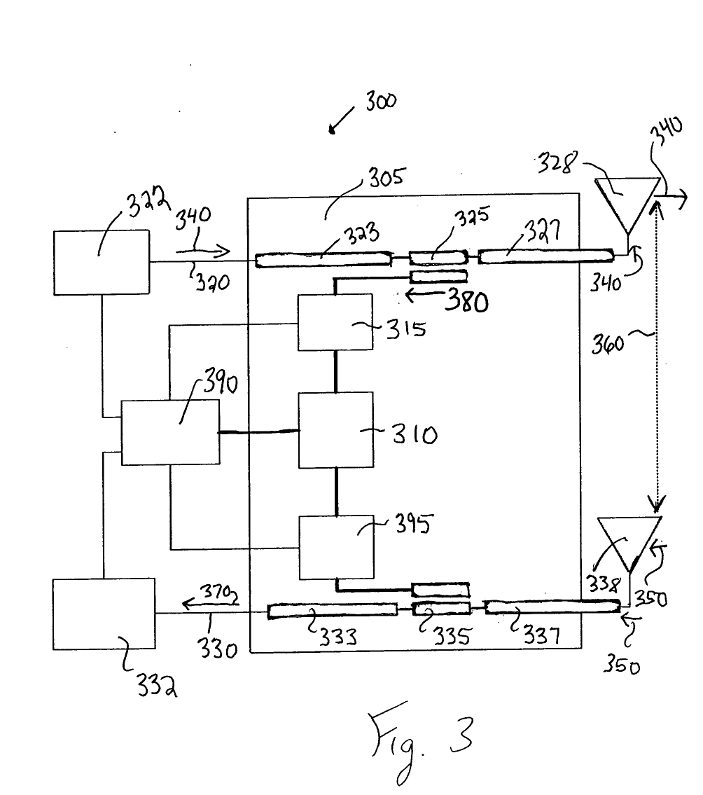

FIG. 3 illustrates a block diagram of an embodiment of elements of a system 300 with a broadband canceller 305 having an adjustable delay line 310. Broadband canceller 305 is coupled to a first transceiver 322 by transmission path 320 and to a second transceiver 332 by transmission path 330. Broadband canceller includes a transmission line 323, a coupler 325, and a cable 327 as part of transmission path 320 from transceiver 322 to its associated antenna 328. Broadband canceller also includes a transmission line 333, a coupler 335, and a cable 337 as part of transmission path 330 from transceiver 332 to its associated antenna 338. Antenna 328 may be an omnidirectional antenna or one or more directional antennas, and antenna 338 may be an omnidirectional antenna or one or more directional antennas. Broadband canceller may also include a phase corrector 395 coupled to a path from transmission path 320 to transmission path 330 along with adjustable time delay 310 and variable attenuator 315. Adjustable time delay 310, variable attenuator 315, and phase corrector 395 are managed by a controller 390.

Transceivers 322, 332 are both transmitting and receiving devices. In an embodiment, transceiver 322 with its associated antenna 328 transmits and receives wireless signals under one wireless protocol, while transceiver 332 with its associated antenna 338 transmits and receives wireless signals under a second wireless protocol. Transceiver 322 acts as an interfering source to transceiver 332, a victim receiver separated by a fixed physical distance from transceiver 322. In an embodiment, transmission path 320 from transceiver 322 and transmission path 330 to transceiver 332 are symmetrical. Signals transmitted from transceiver 332 through its associated antenna 338 impart an interference signal to received signals on transmission 320 for transceiver 322, which becomes a victim receiver to interference source transceiver 332.

Using conventional cancellation methods for amplitude and phase canceling, cancellation is narrowband band and is adjusted for each of the channel center frequencies used in the systems deployed. For example, Bluetooth™ has 80 different channel frequencies, while IEEE 802.11b™ has up to 12 channel frequencies although normally only one of three orthogonal channel frequencies are used. In embodiments as taught herein, time delay cancellation can cancel interference signals over an entire band of interest. In an embodiment, transceiver 322 operates under the Bluetooth™ protocol and transceiver 332 operates under the IEEE 802.11b™ protocol, or vice versa. Other versions of these standards or other communication standards may by used by transceivers 322, 332. Alternately, a transmitter may be used in place of transceiver 322, and a receiver may be used in place transmitter 332.

Along transmission path 320, transmission line 323 provides an 50 ohm transmission line. In an embodiment, transmission line 323 is realized as a stripline transmission line. A transmitted signal 340 from transmission line 323 may be provided to coupler 325. Coupler 325 allows transmitted signal 340 propagating along transmission path 320 to be tapped to be sent to transmission path 330 to provide a sampled signal, i.e. a correction signal, 380 to cancel the interference signal 360 on transmission path 330 caused by the transmitted signal 340 propagating on transmission path 320. In an embodiment, coupler 325 provides a 90° phase to the sampled signal 380 relative to the transmitted signal 340. In an embodiment, coupler 325 is a 10 dB coupler. A cable 327 may connect coupler 325 to antenna 328 for broadcasting transmitted signal 340. Cable 327 provides a fixed delay to the propagation of transmitted signal 340, which is interference signal 360 relative to antenna 338 and transceiver 332.

Along transmission path 330, a cable 337 may connect to a coupler 335 to provide a desired received signal 350 from antenna 338 to transceiver 332 for use by system 300. Cable 337 provides a fixed delay to the propagation of received signal 350 and interference signal 360 that is also captured by antenna 338. Coupler 335 allows sampled signal 380 to be tapped onto transmission path 330 to provide the cancellation of interference signal 360 on transmission path 330 caused by the transmitted signal 340 propagating on transmission path 320. In an embodiment, coupler 335 provides a 90° phase to the sampled signal 380 on coupling to transmission path 330, providing an total of 180° phase shift relative to the transmitted signal 340 from which it was sampled. In an embodiment, coupler 335 is a 10 dB coupler. Transmission line 333 provides an 50 ohm transmission line to transmission path 330. In an embodiment, transmission line 333 is realized as a stripline transmission line.

In embodiments in which a transmitted signal 340 from antenna 328 is not intended to be received at antenna 338, the occurrence of transmitted signal 340 at antenna 338 on transmission path 330 creates an interference signal 360. In an embodiment, antenna 328 and antenna 338 are separated by about 10 inches with about 24 to 30 dB isolation. With this occurrence, a received signal 370 at transceiver 332 includes both the desired received signal 350 from antenna 338 and the interference signal 360. In an embodiment in which transmitted signal 340 is a wireless signal operating under a first protocol and desired received signal 350 is a wireless signal operating under a second protocol, system 300 operating with these two signals in the same or nearby frequency bands is subject to noise, interference due to interference signal 360.

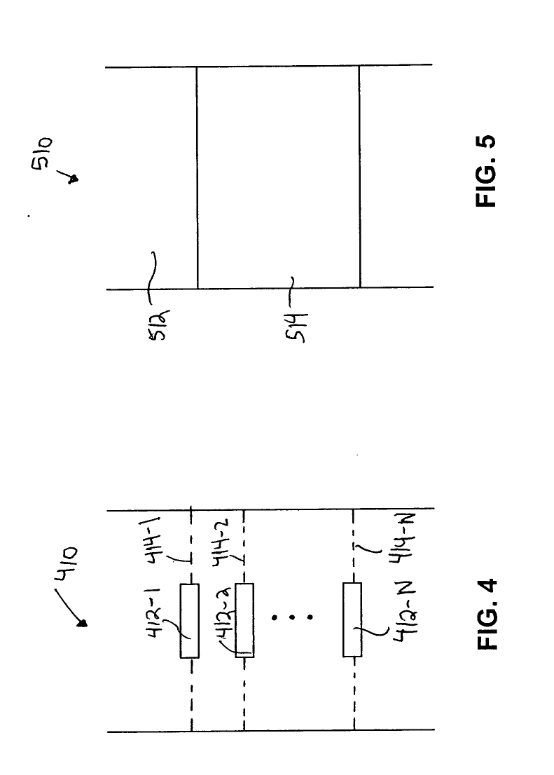

Adjustable delay line 310 provides a time delay to a signal 380 sampled from transmission signal 340, which becomes interference signal 360, to provide broadband cancellation of interference signal 360. Adjustable delay line 310 can be constructed using different embodiments. FIGS. 4 and 5 illustrate embodiments for adjustable delay line 310 to provide substantially broadband cancellation such that received signal 370 is substantially desired received signal 350.

FIG. 4 illustrates an embodiment of an adjustable delay line 410 using a number of microelectromechanical (MEM) switches. Adjustable delay line 410 includes MEM switches 412-1-412-N that are small switches that are disposed very close together. A switch selected from the number of MEM switches 412-1-412-N may be activated by shorting out, or closing, a connecting line 414-1, 414-2 . . . or 414-N to the associated MEM switch to implement the desired time delay. The path length of a signal propagating through adjustable time delay 410, hence its propagation time, is changed by closing a MEM switch which closes one of those steps of the ladder structure shown in FIG. 4, and therefore routes the signal over a different path.

FIG. 5 illustrates an embodiment of an adjustable delay line 410 using a transmission medium 512 having adjustable properties for controlling signal transmission. Transmission medium 512 includes a variable permittivity portion 514 that changes its permittivity under appropriate stimulation. Appropriate stimulation may include, but is not limited to, voltage and temperature. Changing the permittivity of portion 514 changes the transmission speed of a signal through transmission medium 512. Slowing the transmission speed of the signal provides a time delay to the signal. In an embodiment, variable permittivity portion 514 includes barium strontium titanate, abbreviated BST. Other materials having variable permittivity properties may also be used.

The use of an adjustable delay line 310 in system 300 using an embodiment as shown in FIGS. 4, 5 or another embodiment provides a time delay to correction signal 380, which is a sampled version of transmitted signal 340. The imparted time delay provides correction signal 380 with substantially the same time of propagation to a common point on transmission path 330 as interference signal 360. With the general applications for system 300 known, system 300 may be designed in which the path for correction signal 380, i.e. sampled signal 380, and the path of interference signal 360 may be designed such that losses to correction signal 380 correspond to losses in interference signal 360 along an interference path from transmission path 320 to the point on transmission path 330 at which correction signal 380 is coupled to transmission path 330. With the paths designed to match losses, the amplitude of correction signal 380 may substantially be matched to amplitude of interference signal 360.

To compensate for variations in the effects of the different paths on the amplitudes correction signal 380 and interference signal 360, variable attenuator 315 provides attenuation of correction signal 380 to match the amplitude of correction signal 380 to that of interference signal 360 at transmission path 330. In an embodiment, the amplitude matching is realized within about a 0.1 dB accuracy. In an embodiment, the amplitude matching accuracy is within a 0.1 dB.

To provide substantially complete broadband cancellation of interference signal 160, correction or sampled signal 380 is introduced to transmission path 330 with a phase shifted 180° from the phase of interference signal 360. In an embodiment, about a 180° phase shift is provided to correction or sampled signal 380 with about a 90° phase shift applied upon sampling from transmission path 320 using coupler 325 and about a 90° phase shift applied coupling correction or sampled signal 380 to second signal path 130 using coupler 335. To compensate for unknown or unexpected variations to the phases of sampled signal 380 and interference signal 360 due to differences in propagation paths, a phase corrector 395 provides an adjustment to the phase of sampled signal 380 such that at the point of coupling sampled signal 380 to transmission path 330, the phase of sampled signal 380 is substantially shifted 180° from the phase of interference signal 360.

Adjustable delay line 310, variable attenuator 315, and phase corrector 395 are managed by controller 390 that also regulates control signals to transceiver 322 and to transceiver 332 to determine and set the levels of the time delay, amplitude attenuation, and phase correction. In an initialization process for system 300, controller 390 initiates a transmit signal to the transceiver 322 to send out test signals as transmitted signal 340. Controller 390 controls the timing of transmitted test signal 340, generates control signals to transceiver 332 to direct transceiver 332 to look for the test signals. Transceiver 332 provides a continuous output representing received signal 370 to controller 390, which represents the level of the test signal 340 when no received signal 350 is present. Controller 390 measures the amplitude of the received signal 370 to determine what procedures to undertake. A receiver signal strength indicator (RSSI) may be used to provide the indication of the signal strength of received signal 370. In an embodiment, the RSSI provides measuring of test signals in digital format. Alternately, the RSSI provides an analog format. In either embodiment, the RSSI provides an indication of the level of incoming signal from which controller 390 determines the nature of the received signal 370, manages the attenuation of the variable attenuator 315, directs the switching of the time delay in adjustable delay line 310, and regulates the phase adjustment in phase corrector 395. Initialization and setting of the cancellation elements may also be realized sending the test signal from transceiver 332 when the broadband canceller 305 is constructed symmetrically for the two transmission paths 320, 330. Controller 390 may be realized as a microcontroller or as a function of a main processor of system 300.

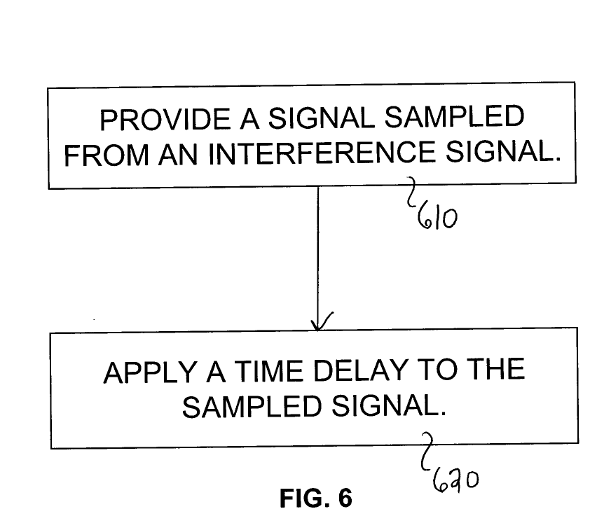

FIG. 6 shows a flowchart of an embodiment of a method for providing broadband cancellation of an interference signal. The embodiment of a method, as shown in FIG. 6, includes providing a signal sampled from an interference signal, at block 610, and applying a time delay to the sampled signal, at block 620. This embodiment of a method for providing broadband cancellation can be realized with various embodiments for an architecture using an adjustable delay line as taught herein. In an embodiment, overall performance is enhanced by amplitude matching and placing the sampled signal in substantially exact anti-phase with the interfering signal over a wide bandwidth. Achieving the anti-phase over the wide bandwidth is largely accomplished through providing the time delay, though a small phase adjustment may be applied to compensate for phase errors introduced in the circuits of the system. In an embodiment, an interference signal for a receiver is produced by a communication signal from a transmitter separate from a receiver co-located in the same system. The transmitter functioning in its normal capacity generating communication signals to devices either internally or externally acts as an interference source to the receiver that may be configured to obtain wireless communication signals from external devices in the same or nearby frequency band of the transmitter. The receiver is a victim to the normal operation of the transmitter co-located in the same system. In an embodiment, the interference is produced between two antennas, both mounted on the same system spaced close together such that there is about a 20 to 30 dB isolation. The physical separation of the antennas and the communication paths to the antennas from their associated transmitters and receivers is fixed and very short. As a result of the short separation of the communication paths, multipath effects or similar perturbations for the interference signal are not significant with respect to an interference channel from direct coupling between a communication path for a transmitter and a communication path for a victim receiver. In an embodiment, the system is a laptop computer or a notebook computer.

To provide substantially broadband cancellation, the time delay is applied to provide the system with the communication signal, i.e. interference signal, from the transmitter and its sampled version on a communication path to the victim receiver. The two signals may differ in amplitude and phase. With a system designed to account for amplitude losses and phase effects, a 180° phase shift can be provided in coupling the sampled signal from the transmitting communication path and coupling to the receiving path. With a system designed to match amplitude losses, the time delay sampled signal with its 180° phase shift substantially provides broadband cancellation of the interference signal to the victim receiver. Alternately, the sampled signal is attenuated to match its amplitude with that of the interference signal at a common point on the communication path to the victim receiver. In an embodiment for a training sequence for a system to initially set the time delay and amplitude for a sampled signal, the signal strength of the combined interference signal and sampled signal is monitored and the time delay to the sampled signal is adjusted and the amplitude of the sampled signal is adjusted to minimize the signal strength. The time delay and the attenuation may be adjusted independently of each other. In an embodiment, the signal strength is minimized by adjusting the time delay in the path of the sampled signal with the adjustment in the amplitude of the sampled being negligible. In an embodiment, the signal strength is minimized by adjusting the amplitude of the sampled signal with the adjustment in the time delay in the path of the sampled signal being negligible.

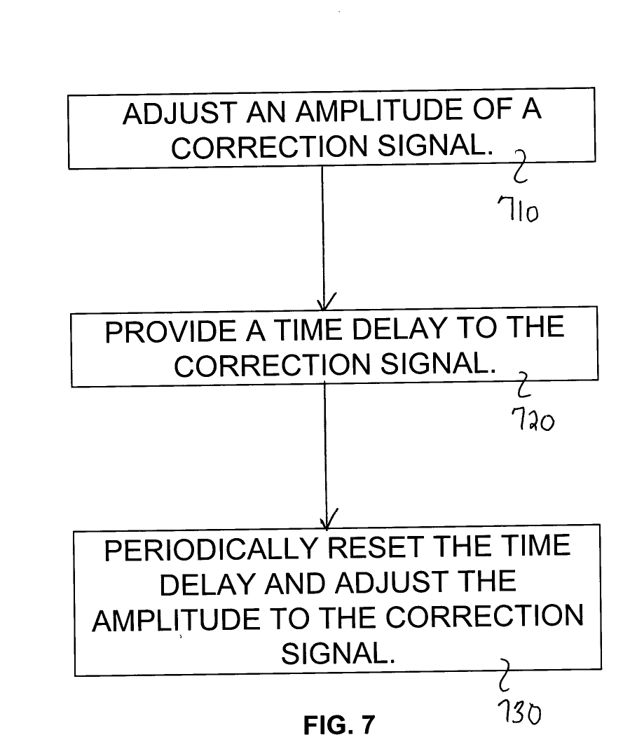

FIG. 7 shows a flowchart of an embodiment of a method for providing broadband cancellation of an interference signal. The embodiment of a method, as shown in FIG. 7, includes adjusting an amplitude of a correction signal, at block 710, providing a time delay to the correction signal, at block 720, and periodically resetting the time delay and adjusting the amplitude to the correction signal, at block 730. This embodiment of a method for providing broadband cancellation may be realized with various embodiments for an architecture having an adjustable delay line as taught herein. In an embodiment, overall performance is enhanced by amplitude matching and placing the sampled signal in substantially exact anti-phase with the interfering signal over a wide bandwidth. Achieving the anti-phase over the wide bandwidth is largely accomplished through providing the time delay, though a small phase adjustment may be applied to compensate for phase errors introduced in the circuits of the system.

In an embodiment, the correction signal is provided by sampling a communication signal from a transmitter along a first communication path. This transmitted signal acts an interference signal to a receiver co-located with the transmitter in an apparatus and coupled to a second communication path. The correction signal is sent along a path through a time delay line and a variable attenuator to the second communication path. Alternately, the correction signal is provided to the correction path through an adjustable delay line and a variable attenuator by simultaneously transmitting the communication signal from the transmitter onto the first communication path and onto a correction path coupled to the time delay time and the variable attenuator.

The path of the correction signal is different from an interference path traveled by the interference signal from the first communication path to the second communication path. In an embodiment, the interference path is an interference channel between the two antennas co-located within a short fixed distance. In an embodiment, one antenna transmits and receives communication signals using one wireless protocol and the second antenna transmits and receives communication signals using a second wireless protocol at substantially the same frequency. In one instance, the two different protocols are Bluetooth™ and IEEE 802.11b™. Other versions of these standards or other communication standards may by used in transmitting and receiving the two wireless signals. In an another embodiment, a high speed data bus provides a propagation path for communication signals between internal devices of a system with the propagation of these internal communication signals on the data bus providing noise or interference on a wireless channel collocated with the data bus in the system. In an another embodiment, a high speed data bus provides communication signals for one or more devices that propagate as noise or interference to other devices coupled to the data bus for receiving other signals.

The time delay, phase shift correction, and amplitude adjustment are provided in several stages. In the system design, the routes for two communication routes are selected such that multipath effects for the interference signal are not significant with respect to an interference channel from direct coupling between the first communication path and the second communication path. Upon initialization of the system, such as power up sequencing for a computer, a test is generated to determine the appropriate time delay and amplitude adjustment to substantially provide broadband cancellation of an interference signal. The initialization of the time delay and amplitude adjustment may require an iterative process, which is performed when the system is not receiving operational signals by the victim receiver. Then, periodically, when the system is not transmitting or receiving operational signals, a test can be performed to minimize the reception of test signals generated by the transmitter and collected by the victim receiver.

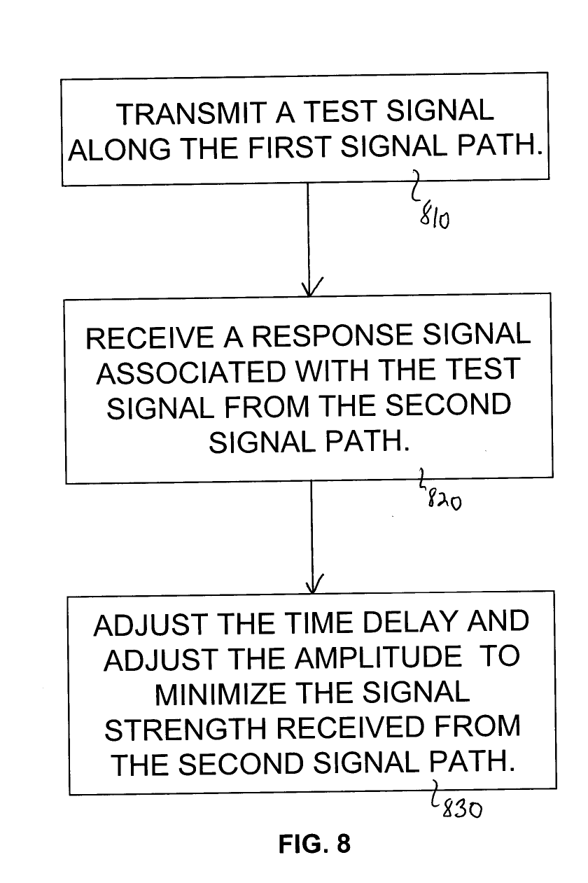

FIG. 8 shows a flowchart of an embodiment of a method for providing broadband cancellation of an interference signal using a test signal. The embodiment of a method, as shown in FIG. 8, includes transmitting a test signal along the first signal path, at block 810, receiving a response signal associated with the test signal from the second signal path, at block 820, and adjusting the time delay and adjusting the amplitude to minimize the signal strength received from the second signal path, at block 830. This embodiment of a method for providing broadband cancellation may be realized with various embodiments for an architecture having an adjustable delay line as taught herein. In an embodiment, overall performance is enhanced by amplitude matching and placing the sampled signal in substantially exact anti-phase with the interfering signal over a wide bandwidth. Achieving the anti-phase over the wide bandwidth is largely accomplished through providing the time delay, though a small phase adjustment may be applied to compensate for phase errors introduced in the circuits of the system.

Test signals are used to calibrate the time delay and amplitude adjustment. Generating test signals on the first communication path to provide an interference signal on the second communication path provides a characterization of the interference channel. It is an initial set-up procedure. When the system is installed in a computer, the initial calibration can be performed every time the computer is switched on or rebooted. After the initialization, a periodic check to correct for any subsequent perturbations that may have affected the system can be performed.

A fairly accurate estimate of the amount for the time delay is provided by the physical layout of the circuit and relationship between the first and second communication paths. As a result of the known physical layout, a range for the time delay is provided. Then, an iterative process is performed to determine the cancellation to be implemented. The iterative process effectively sweeps through a set of time delays and amplitude variations in which the set that yields the lowest power or signal strength on the other side of the channel at the victim receiver is selected. The iterative process may include testing at a number of frequencies for the test signals. Instead of measuring an absolute time delay the iterative process is directed to provide an optimal cancellation. Alternatively, the time delay is measured and stored in a memory to be used by a controller to manage the adjustment of the time delay to the correction signal. In an embodiment, the interference path is between two fixed antennas operating under two different protocols in the same or nearby frequency bands.

Various embodiments for providing interference cancellation by time delay techniques can be used in conjunction with adaptive frequency hopping techniques. These embodiments for interference cancellation may substantially provide for cancellation across an entire band of interest. Then, calibration for each frequency in the frequency hop sequence, which is required for a conventional phase correction technique, can be avoided. Embodiments for time delay broadband cancellation provide for the calibration of a center frequency without having to calibrate for each frequency of interest in a selected frequency band. In an embodiment in which a signal is transmitted as a Bluetooth™ signal that hops from about 2.40 GHz to about 2.480 GHz, a time delay can be set for a center frequency at 2.440 GHz to provide broadband cancellation across the whole frequency band.

The calibration on initial startup and the periodic adjustment to the time delay is performed while the system is idle with respect to generating and receiving operational signals. A controller manages the procedures for adjusting the time delay and the amplitude adjustment and any phase correction. A flag can be provided to the controller to prevent the controller from initiating a further testing sequence during operational processing of communication signals. In an embodiment, when operational signal traffic is either being transmitted or being received in the system, the control basically holds the time delay, amplitude adjustment, and any phase correction static. In an embodiment, the nature of the traffic from both a transmission operation and a reception operation is intermittent such that it lasts for a time period ranging from less than a few milliseconds to less than a hundred milliseconds. Generally, the operational signals are on the system communication paths for a very short duration. At the end of each operational transmission packet or operational receiver packet, another calibration may be periodically run when the operational communication channels are free. Between testing procedures or calibrations, the time delay, amplitude adjustment, and phase correction parameters are not changed and their settings, or values, may be held in a memory. In an embodiment, these parameters are provided in a look-up table accessible by the controller.

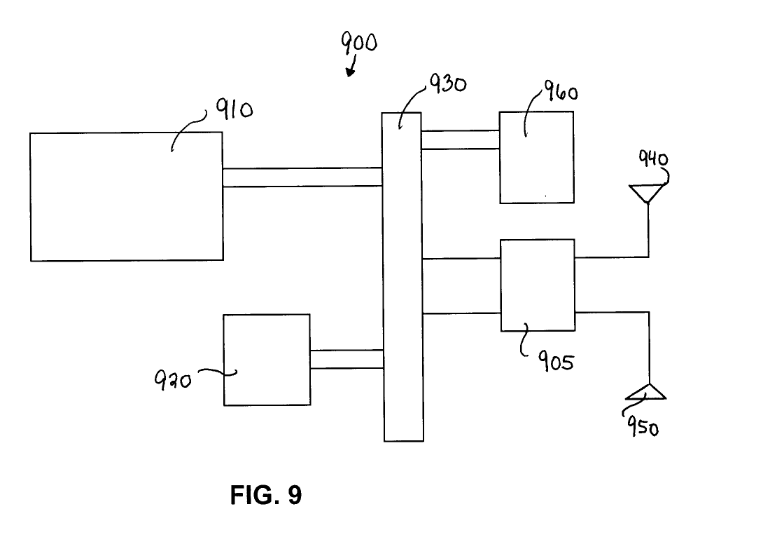

FIG. 9 illustrates a block diagram of an embodiment of a system 900 having a broadband canceller 905. System 900 includes a controller 910, an electronic apparatus 920, and a bus 930, where bus 930 provides electrical conductivity between controller 910 and electronic apparatus 920, and between controller 910 and broadband canceller 905. An embodiment may include an additional peripheral device or devices 960 coupled to bus 930. In an embodiment broadband canceller 905 is coupled to an antenna 940. In an embodiment broadband canceller 905 is coupled to an antenna 940 and antenna 950. Electronic system 900 may include, but is not limited to, information handling devices, wireless systems, telecommunication systems, fiber optic systems, electro-optic systems, and computers.

In an embodiment, controller 910 transmits and receives wireless signals using antenna 940 and antenna 950, where antenna 940 is operated using one wireless protocol and antenna 950 is operated using another wireless protocol. In an embodiment, one wireless protocol is Bluetooth™ and the other wireless protocol is IEEE 802.11b™. Other versions of these standards or other communication standards may by used in transmitting and receiving the two wireless signals. In an another embodiment, bus 930 is a high speed data bus that provides a propagation path for communication signals between internal devices of system 900 with the propagation of these internal communication signals on data bus 930 providing noise or interference on a wireless channel, such as a communication path including antenna 950, collocated with the data bus 930 in system 900. In an another embodiment, bus 930 is a high speed data bus that provides communication signals for one or more devices that propagate as noise or interference to other devices coupled to data bus 930 for receiving other signals.

Broadband canceller 905, configured in an embodiment as taught herein, provides broadband cancellation of an interference signal from one antenna to the other antenna when the two antennas are operating with signals in the same or nearby frequency bands. In an embodiment controller 910 is a processor. In an embodiment, controller 910 is processor and peripheral devices 960 include a cancellation controller to manage broadband canceller 905 and transceivers for applying and acquiring wireless signals from antenna 940 and antenna 950.

Peripheral devices 960 may include displays, additional storage memory, or other control devices that may operate in conjunction with controller 910. Alternately, peripheral devices 960 may include displays, additional storage memory, or other control devices that may operate in conjunction with controller 910, broadband canceller 905, and/or electronic apparatus 920.

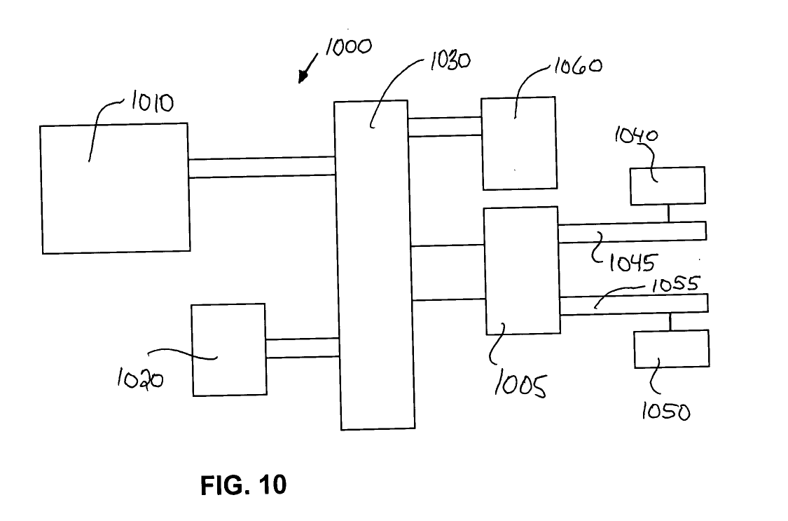

FIG. 10 illustrates a block diagram of an embodiment of a system 1000 having a broadband canceller 1005. System 1000 includes a controller 1010, an electronic apparatus 1020, and a bus 1030, where bus 1030 provides electrical conductivity between controller 1010 and electronic apparatus 1020, and between controller 1010 and broadband canceller 1005. An embodiment may include an additional peripheral device or devices 1060 coupled to bus 1030. In an embodiment, broadband canceller 1005 is coupled to data module 1040 that receives data from communication path 1045, which may be a bus. Broadband canceller 1005 is also coupled to a communication path 1055 to another data module 1050. A transmitter to send information to data module 1040 and a receiver to receive information from data module 1050 may be provided by peripheral devices 1060 or controller 1010, where the transmitter and receiver are collated in system 1000, that is, located in the same system separated by a relatively short distance. In an embodiment, data module 1050 is a receiving module having an antenna for receiving wireless data and communications for system 1000 having receiving module 1050 as its single receiver. Electronic system 1000 may include, but is not limited to, information handling devices, wireless systems, telecommunication systems, fiber optic systems, electro-optic systems, and computers.

In an embodiment, controller 1010 or peripheral devices 1060 transmit and receive signals in communication with data module 1040 using communication path 1045, and receives signals external to system 1000 from receiving module 1050. In an embodiment, receiving module 1050 is operating using a wireless protocol such as Bluetooth™ or IEEE 802.11b™. Other versions of these standards or other communication standards may by used by receiving module 1050. In an another embodiment, bus 1045 is a high speed data bus that provides a propagation path for communication signals between internal devices of system 1000 with data module 1040 providing noise or interference on a wireless channel, such as the combination of the receiving module 1050 and communication path 1055. In another embodiment, communication path 1055 is a bus and data module 1050 is an electronic apparatus communicating with other devices of system 1000 over bus 1055.

Broadband canceller 1005, configured in an embodiment as taught herein, provides broadband cancellation of an interference signal from communication path 1045 including data module 1040 to communication path 1055 including data module 1050, where data module 1040 and data module 1050 are operating with signals in the same or nearby frequency bands. In an embodiment controller 1010 is a processor. In an embodiment, controller 1010 is processor and peripheral devices 1060 include a cancellation controller to manage broadband canceller 1005 and transceivers for applying and acquiring signals from data module 1040 and data module 1050.

Peripheral devices 1060 may include displays, additional storage memory, or other control devices that may operate in conjunction with controller 1010. Alternately, peripheral devices 1060 may include displays, additional storage memory, or other control devices that may operate in conjunction with controller 1010, broadband canceller 1005, and/or electronic apparatus 1020.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon reviewing the above description. The scope of the present invention includes any other applications in which embodiment of the above structures and fabrication methods are used. The scope of the embodiments of the present invention should be determined with reference to the appended claims, along with the full scope of equivalents to which such claims are entitled.

1. A method comprising:
applying a time delay to a signal sampled from an interference signal to provide substantially broadband cancellation of the interference signal.

2. The method of claim 1, wherein providing substantially broadband cancellation includes substantially matching an amplitude of the sampled signal with an amplitude of the interference signal.

3. The method of claim 1, wherein providing substantially broadband cancellation includes substantially matching an amplitude of the sampled signal with an amplitude of the interference signal to within about a 0.1 db accuracy.

4. The method of claim 1, wherein the method further includes providing about a 180° phase shift to the signal sampled from the interference signal.

5. The method of claim 4, wherein providing about a 180° phase shift to the signal sampled from the interference signal includes providing about a 90° phase shift upon sampling and providing about a 90° phase shift coupling the sampled signal to a signal path receiving the interference signal.

6. The method of claim 1, wherein the method further includes generating the interference signal as a signal from a transmitter through its associated antenna with the substantially broadband cancellation of the interference signal applied to the interference signal received by a second antenna associated with a receiver.

7. The method of claim 1, wherein the method further includes monitoring a signal strength received from a signal path receiving the sampled signal and the interference signal and adjusting the time delay to minimize the signal strength received from the signal path.

8. The method of claim 1, wherein providing substantially broadband cancellation includes providing substantially broadband cancellation to an interference signal, where the interference signal propagates from a transmitting antenna of a device to a receiving antenna of the device, the transmitting antenna using a first wireless protocol and the receiving antenna using a second wireless protocol.

9. A method comprising:
providing a time delay to a correction signal propagating from a first signal path to a second signal path;
adjusting an amplitude of the correction signal; and
periodically resetting the time delay and adjusting the amplitude of the correction signal to provide substantially broadband cancellation of an interference signal propagating over an interference path between the first signal path and the second signal path, the interference path separate from a primary path of the correction signal.

10. The method of claim 9, wherein the method further includes sampling the interference signal to generate the correction signal.

11. The method of claim 9, wherein periodically resetting the time delay and adjusting the amplitude occurs during a time interval in which no communication signals are being externally transmitted or received along the first signal path or the second signal path.

12. The method of claim 9, wherein the method further includes providing an initial time delay and an initial amplitude adjustment during a start-up process by a iterative process that includes:
transmitting a test signal along the first signal path;
receiving a response signal associated with the test signal from the second signal path, the response signal having a signal strength; and
adjusting the time delay and adjusting the amplitude to minimize the signal strength.

13. An apparatus comprising:
a first signal path;
a second signal path;
an adjustable delay line to provide a time delay to a correction signal propagating from the first signal path to the second signal path; and
a variable attenuator coupled to the adjustable delay line such that the correction signal matches an interference signal propagating from the first signal path to the second signal path to provide substantial broadband cancellation of the interference signal.

14. The apparatus of claim 13, wherein the adjustable delay line includes one or more microelectromechanical switches.

15. The apparatus of claim 13, wherein the adjustable delay line includes a material whose permittivity can be changed to adjust the speed of propagation of the correction signal.

16. The apparatus of claim 15, wherein the material is barium strontium titanate.

17. The apparatus of claim 13, further including a first tap to couple the correction signal to a primary path from the first signal path to the adjustable delay.

18. The apparatus of claim 17, further including a second tap to couple the primary path to the second signal path.

19. The apparatus of claim 13, further including a phase corrector coupled to the adjustable delay line.

20. The apparatus of claim 19, further including a controller to manage the variable attenuator, the adjustable delay line, and the phase corrector.

21. The apparatus of claim 13, wherein the first signal path includes a transmitter and a first antenna, and the second signal path includes a receiver and a second antenna.

22. The apparatus of claim 21, wherein the first signal path further includes a transmission line coupled to the transmitter and a first cable having a fixed propagation delay coupled to the first antenna.

23. The apparatus of claim 21, wherein the transmitter is a first transceiver that uses a first wireless protocol and the receiver is a second transceiver that uses a second wireless protocol.

24. A system comprising:
a processor;
a memory coupled to the processor;
a first signal path on which signals responsive to the processor are transmitted;
a first antenna coupled to the first signal path to transmit the signals from the first signal path;
a second signal path on which signals to provide a communication to the processor are received;
an adjustable delay line to provide a time delay to a correction signal propagating from the first signal path to the second signal path; and
a variable attenuator coupled to the adjustable delay line such that the correction signal matches an interference signal propagating from the first signal path to the second signal path to provide substantial broadband cancellation of the interference signal.

25. The system of claim 24, wherein the first signal path includes a transmitter to transmit a first signal using a first protocol and the second path includes a receiver and a second antenna to receive a second signal using a second protocol.

26. The system of claim 24, further including a controller to manage the variable attenuator and the adjustable delay line.

27. The system of claim 24, further including a first tap to couple the correction signal to a primary path from the first signal path to the adjustable delay, and a second tap to couple the primary path to the second signal path, wherein the first tap and the second tap each provide about a 90° phase shift to the correction signal.

28. The system of claim 24, wherein the system further includes a data transmitting module coupled to the first signal path collocated with a data receiving module coupled to the second signal path.

29. The system of claim 24, wherein the system is a computer.

30. The system of claim 24, wherein the system is a laptop computer.
